(19) United States
(12) Patent Application Publication
(10) Pub. No.: US 2001/0015726 A1
(43) Pub. Date: Aug. 23, 2001

(54) ALTERED MULTI-RESOLUTION ANALYSIS FOR SCIENTIFIC DATA COMPLEXITY REDUCTION

(76) Inventor: SIMON HAYHURST, MOUNTAIN VIEW, CA (US)

Correspondence Address: WAGNER MURABITO & HAO, THIRD FLOOR, TWO NORTH MARKET STREET, SAN JOSE, CA, 95113

(21) Appl. No.: 09/065,764

(22) Filed: Apr. 23, 1998

(51) Int. Cl. G06F 3/00; G06F 13/00; G06T 17/00; G06T 11/20

(52) U.S. Cl. 345/428; 345/440

(57) ABSTRACT

Altered multi-resolution analysis for scientific data complexity reduction. The present invention is a method for rendering accurate computer graphics models together with their corresponding accurate levels-of-detail without having to store repetitive data representing each level-of-detail. One method in accordance with the present invention includes a computer system, software instructions, and engineering or scientific data related to a physical process. Specifically, the present invention directs the computer system to use an asymmetric wavelet basis function to graphically propagate specific modeling data corresponding to a high level-of-detail down to a lower level-of-detail. During this process, the present invention also directs the computer system to store bits within a bit field in order to decode the data corresponding to the lower level-of-detail at some later time. Furthermore, the present invention is also able to reverse the previous process by directing the computer system to invert the asymmetric wavelet basis function utilizing the bit field in order to graphically reconstitute the modeling data corresponding to the higher level-of-detail from the data corresponding to the lower level-of-detail.

### TECHNICAL FIELD

The present invention relates to the field of computer software. More specifically, the present invention relates to computer software used to implement scientific visualization.

### BACKGROUND ART

Computers are useful functional devices which are fabricated in a variety of sizes ranging from computers which occupy large office space down to computers which are held in one's hand. These varying sizes of computers also perform an extremely wide variety of useful operations, depending on the software which is installed within their particular memory storage device. For instance, computers can manage numerous financial transactions of a bank, control the fabrication of items ranging from automobiles down to integrated circuit chips, store addresses and telephone numbers of acquaintances, enable someone to produce and edit documents, along with transmitting and receiving data. Furthermore, computers are also used to graphically analyze and model different types of engineering and scientific data in order to more fully understand it. For instance, computers can be used to graphically analyze car crashes, thermodynamics, elements of the human body, engine operations, structural elements of an airplane, structural supports of bridges, and the like.

There are different prior art techniques implemented with software which enable computers to graphically analyze and model different types of engineering and scientific data. One of the typical prior art techniques of computer graphics modeling is commonly referred to as engineering or scientific visualization, wherein the software directs a computer system to translate specific given data into a graphics representation of a physical object or process, which is then shown on a display screen of the computer. Typically, engineering visualization software enables a computer user to direct the computer to alter the viewing angle and the distance that a particular graphics model is viewed from (e.g., close up or far away). In this manner, the computer user is able to view different levels-of-detail or resolution of the particular model. As such, engineering visualization software is very useful to computer users for graphically analyzing and modeling engineering and/or scientific data.

Within prior art computer systems, there are different techniques for enabling engineering visualization software to produce different levels-of-detail of a particular graphics model from its corresponding data. One of the typical techniques involves a computer user predetermining the desired levels-of-detail of the particular graphics model to be viewed and then separately storing the corresponding data of each level-of-detail of-detail within the computer system memory. As such, the engineering visualization software utilizes the stored data to enable a computer user to view the particular graphics model from different levels-of-detail.

There are disadvantages associated with the prior art technique of producing different levels-of-detail of a particular graphics model, as described above. One of the main disadvantages of this prior art technique is that the stored levels-of-detail can occupy an extremely large amount of computer system memory, thereby limiting the amount of memory space available for subsequently storing software. For example, assume that the corresponding data used to render a particular graphics model on a computer display screen utilizes 5 gigabytes (GB) of memory space. Furthermore, if a computer user desires to be able to view ten levels-of-detail of that particular graphics model, the corresponding data used to render these different levels-of-detail utilizes an additional 5 GB of memory space. As such, 10 GB of computer system memory space is utilized in order to render the graphics model along with its corresponding ten levels-of-detail on the display screen. Therefore, during the prior art technique described above, an extremely large amount of computer system memory can be utilized which disadvantageously limits the amount of memory space available for subsequently storing software. It should be appreciated that the disadvantage of the prior art technique described above has more of a detrimental effect on computer systems having limited memory space than on computer systems having enormous amounts of memory space.

It should be further appreciated that there are other disadvantages associated with the prior art technique of producing different levels-of-detail of a particular graphics model, as described above. For example, a computer system using the prior art technique may be unable to properly render different levels-of-detail of a graphical model on its display screen because of a limited graphics bandwidth of its central processing unit (CPU), buses, graphics card, or the like.

Typically, engineering visualization software utilizes large amounts of memory in order to graphically render particular models and their corresponding levels-of-detail. It should be appreciated that within the field of prior art computer graphics which is unrelated to engineering visualization, there are a variety of schemes for rendering different levels-of-detail of a graphics image without having to occupy large amounts of memory. One prior art scheme utilizes wavelets, which is well known by those skilled in the art, and is discussed in a number of publications, such as Wavelets for Computer Graphics; Theory and Applications by Eric J. Stollnitz et al., Morgan Kaufmann Publishers, Inc., (1996). A basic explanation of wavelets is provided below from pages 9-11 of that publication.

To get a sense for how wavelets work, let's start out with a simple example. Suppose we are given a one-dimensional “image” with a resolution of 4 pixels, having the following pixel values:

### [9 73 5]

This image can be represented in the Haar basis, the simplest wavelet basis, by computing a wavelet transform as follows. Start by averaging the pixels together, pairwise, to get a new lower-resolution image with these pixel values:

### [8 4]

Clearly, some information has been lost in this averaging and down-sampling process. In order to be able to recover the original four pixel values from the two average pixels, we need to store some detail coefficients, which capture that missing information. In our example, we will choose 1 for the first detail coefficient, since the average we computed is 1 less than 9 and 1 more than 7. This single number allows us to recover the first two pixels of out original four-pixel image. Similarly, the second detail coefficient is −1, since 4+(−1)=3and 4−(−1)=5.

Summarizing, we have so far decomposed the original image into a lower-resolution (two-pixel) version and detail coefficients as follows:

| Resolution | Averages | Detail Coefficients |
|---|---|---|
| 4 | [9 7 3 5] | |
| 2 | [8 4] | [1 −1] |

Repeating this process recursively on the averages gives the full decomposition:

| Resolution | Averages | Detail Coefficients |
|---|---|---|
| 4 | [9 7 3 5] | |
| 2 | [8 4] | [1 −1] |
| 1 | [6] | [2 ] |

Finally, we will define the wavelet transform (also called the wavelet decomposition) of the original four-pixel image to be the single coefficient representing the overall average of the original image, followed by the detail coefficients in order of increasing resolution. Thus, for the one-dimensional Haar basis, the wavelet transform of our original four-pixel image is given by

### [6 2 1−1]

The way we computed the wavelet transform, by recursively averaging and differencing coefficients, is called a filter bank . . . Note that no information has been gained or lost by this process: The original image had four coefficients, and so does the transform. Also note that, given the transform, we can reconstruct the image to any resolution by recursively adding and subtracting the detail coefficients from the lower-resolution versions.

Therefore, wavelets basically involve averaging the original data corresponding to a graphics image in order to render the different levels-of-detail, while using the same memory space as the original data. A prior art wavelet transform scheme is typically not used in conjunction with engineering visualization software because the resulting levels-of-detail of a graphics model rendered on a display screen are not very useful to engineers and scientists. The reason is that critical engineering and scientific data is graphically obscured within the resulting levels-of-detail by the averaging process of the wavelet transform.

Therefore, it would be advantageous to provide a method for rendering accurate computer graphics models together with their corresponding accurate levels-of-detail without having to store repetitive data representing each level-of-detail. The present invention provides this advantage.

### DISCLOSURE OF THE INVENTION

The present invention includes a method for rendering accurate computer graphics models together with their corresponding accurate levels-of-detail without having to store repetitive data representing each level-of-detail. One method in accordance with the present invention includes a computer system, software instructions, and engineering or scientific data related to a physical process. Specifically, the present invention directs the computer system to use an asymmetric wavelet basis function to graphically propagate specific modeling data corresponding to a high level-of-detail down to a lower level-of-detail. During this process, the present invention also directs the computer system to store bits within a bit field in order to decode the data corresponding to the lower level-of-detail at some later time. Furthermore, the present invention is also able to reverse the previous process by directing the computer system to invert the asymmetric wavelet basis function utilizing the bit field in order to graphically reconstitute the modeling data corresponding to the higher level-of-detail from the data corresponding to the lower level-of-detail.

One advantage of the present invention is that it provides a method of performing computer graphics multi-resolution analysis with information propagation. So for example, if a broad overview of a computer graphics model is being viewed and one specific value is very important to a computer user, the present invention provides a method which causes that value to become conspicuous. Moreover, another advantage of the present invention is that it enables an asymmetric basis function to skew a chosen piece of information so that it has a spreading effect at a low level-of-detail, so it has a region of increase. Therefore, the data is not directly transmitted between different levels-of-detail, but instead spreads so that it has a higher region of influence. Additionally, another advantage of the present invention is that it provides a method of graphically simplifying scientific data while not losing any information at different levels-of-detail. Furthermore, another advantage of the present invention is that it provides a method of compact storage of scientific data, which contains all of the original information while allowing the propagation of specific information into different graphical levels-of-detail. Specifically, the memory space used to store the original data, in accordance with the present invention, substantially maintains the same size as different graphics levels-of-detail of a model are rendered on a computer display screen.

These and other advantages of the present invention will no doubt become obvious to those of ordinary skill in the art after having read the following detailed description of the preferred embodiments which are illustrated in the drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a computer system used in accordance with the present invention.

FIG. 2 is a flowchart of a method in accordance with one embodiment of the present invention for graphically propagating modeling data corresponding to a high level-of-detail down to a lower level-of-detail using an asymmetric wavelet basis function.

FIG. 3A is a block diagram illustrating one embodiment of how the method of FIG. 2 directs a computer system to propagate particular values of raw data corresponding to a high level-of-detail down to data corresponding to a lower level-of-detail.

FIG. 3B is a block diagram illustrating one embodiment of the data used by the method of FIG. 2 to render a low level-of-detail model on a display screen of a computer system.

FIG. 4 is a flowchart of a method in accordance with one embodiment of the present invention for graphically reconstituting modeling data corresponding to a higher level-of-detail from data corresponding to a lower level-of-detail by inverting an asymmetric wavelet basis function process.

FIG. 5A is a block diagram illustrating one embodiment of how the method of FIG. 4 directs a computer system to reconstitute raw data corresponding to a higher level-of-detail by utilizing a bit field and data corresponding to a lower level-of-detail.

FIG. 5B is a block diagram illustrating one embodiment of the data used by the method of FIG. 4 to render a high level-of-detail model on a display screen of a computer system.

### BEST MODE FOR CARRYING OUT THE INVENTION

In the following detailed description of the present invention, a method for computer graphics multi-resolution analysis for scientific data complexity reduction, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow (e.g., processes 200 and 400) are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art.

Unless specifically stated otherwise as apparent from the following discussions, it is understood that throughout discussions of the present invention, discussions utilizing terms such as “processing” or “computing” or “generating” or “calculating” or “determining” or “displaying” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display screens.

As previously described above, computers can perform an extremely wide variety of useful operations, depending on the software which is installed within their particular memory storage device. For instance, computers can control the fabrication of items ranging from integrated circuit chips up to automobiles, store telephone numbers and addresses of acquaintances, enable someone to produce and edit documents, manage numerous financial transactions of a bank, along with transmitting and receiving data. Furthermore, computers are also used to graphically analyze and model different types of engineering and scientific data in order to more fully understand it. For instance, computers can be used to graphically analyze car crashes, thermodynamics, elements of the human body, engine operations, structural elements of an airplane, structural supports of bridges, and the like.

There are different techniques implemented with software which enable computers to graphically analyze and model different types of engineering and scientific data. One of the typical techniques of computer graphics modeling is commonly referred to as engineering or scientific visualization, wherein the software directs a computer system to translate specific given data into a graphics representation of a physical object or process, which is then shown on a display screen of the computer. Typically, engineering visualization software enables a computer user to direct the computer to alter the viewing angle and the distance that a particular graphics model is viewed from (e.g., close up or far away). In this manner, the computer user is able to view different levels-of-detail or resolution of the particular model. As such, engineering visualization software is very useful to computer users for graphically analyzing and modeling engineering and/or scientific data.

The present invention is a method for rendering accurate computer graphics models together with their corresponding accurate levels-of-detail without having to store repetitive data representing each level-of-detail. One method in accordance with the present invention includes a computer system, software instructions, and engineering or scientific data related to a physical process. Specifically, the present invention directs the computer system to use an asymmetric wavelet basis function to graphically propagate specific modeling data corresponding to a high level-of-detail down to a lower level-of-detail. During this process, the present invention also directs the computer system to store bits within a bit field in order to decode the data corresponding to the lower level-of-detail at some later time. Furthermore, the present invention is also able to reverse the previous process by directing the computer system to invert the asymmetric wavelet basis function utilizing the bit field in order to graphically reconstitute the modeling data corresponding to the higher level-of-detail from the data corresponding to the lower level-of-detail.

One advantage of the present invention is that it provides a method of performing computer graphics multi-resolution analysis with information propagation. So for example, if a broad overview of a computer graphics model is being viewed and one specific value is very important to a computer user, the present invention provides a method which causes that value to become conspicuous. Moreover, another advantage of the present invention is that it enables an asymmetric basis function to skew a chosen piece of information so that it has a spreading effect at a low level-of-detail, so it has a region of increase. Therefore, the data is not directly transmitted between different levels-of-detail, but instead spreads so that it has a higher region of influence. Additionally, another advantage of the present invention is that it provides a method of graphically simplifying scientific data while not losing any information at different levels-of-detail. Furthermore, another advantage of the present invention is that it provides a method of compact storage of scientific data, which contains all of the original information while allowing the propagation of specific information into different graphical levels-of-detail. Specifically, the memory space used to store the original data, in accordance with the present invention, substantially maintains the same size as different graphics levels-of-detail of a model are rendered on a computer display screen. Furthermore, another advantage of the present invention is that it allows unnecessary detail information of graphical models to be stored within memory far more compactly than what is typically possible with other prior art “lossless” methods. As such, the present invention enables less powerful computer systems to perform dynamic zooming of rendered graphical models. Additionally, the dynamic zooming in accordance with one embodiment of the present invention is implemented by utilizing a precise and separable region of detail information, which reduces the amount of information the computer system has to manipulate. Therefore, this process increases the maximum amount of complexity that can be handled by a computer system.

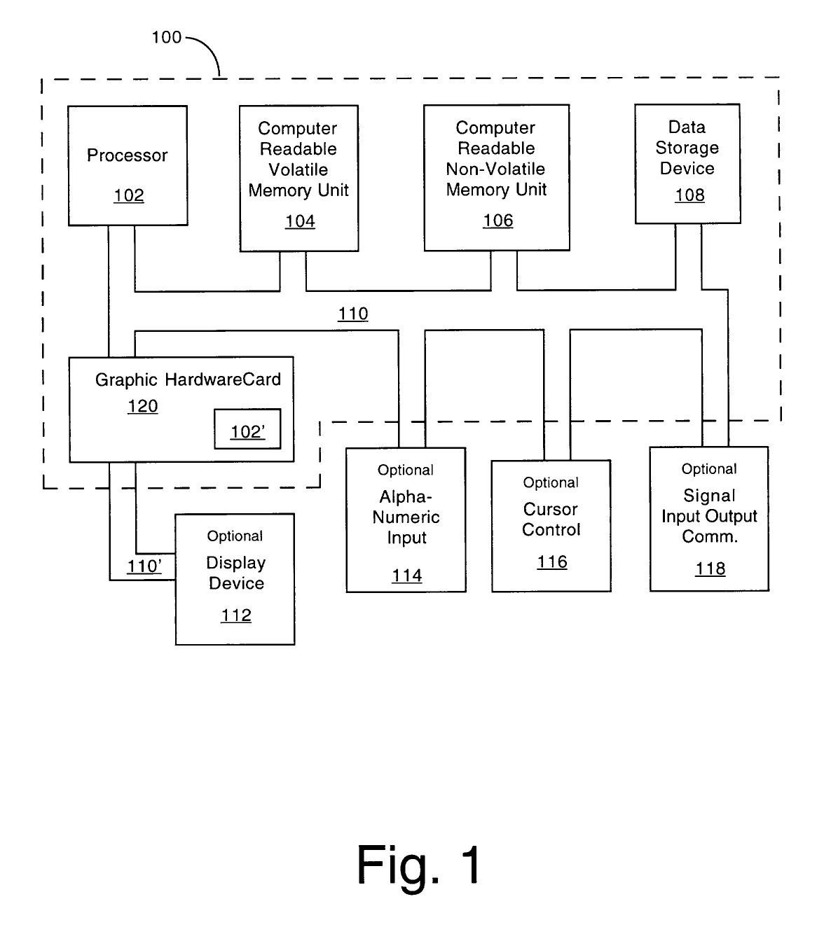

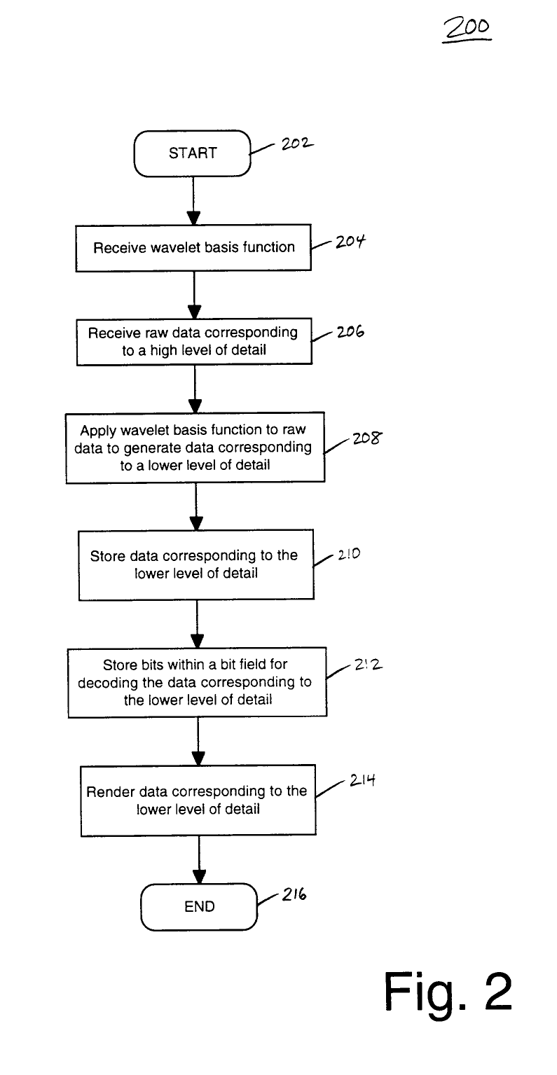

FIG. 1 is a block diagram of a computer system 100 used in accordance with the present invention. Within the following discussions of the present invention, certain processes and steps are discussed (e.g., process 200 of FIG. 2) that are realized, in one embodiment, as a series of instructions (e.g., software program) that reside within computer readable memory units of computer system 100 and executed by processors of computer system 100. When executed, the instructions cause computer system 100 to perform specific actions and exhibit specific behavior which is described in detail below.

In general, computer system 100 of FIG. 1 used by an embodiment of the present invention comprises an address/data bus 110 for communicating information, one or more central processors 102 coupled with bus 110 for processing information and instructions, a computer readable volatile memory unit 104 (e.g., random access memory, static RAM, dynamic RAM, etc.) coupled with bus 110 for storing information and instructions (e.g., graphics software) for central processor(s) 102, a computer readable non-volatile memory unit 106 (e.g., read only memory, programmable ROM, flash memory, EPROM, EEPROM, etc.) coupled with bus 110 for storing static information and instructions for processor(s) 102. Computer system 100 also includes a mass storage computer readable data storage device 108 such as a magnetic or optical disk and disk drive (e.g., hard drive or floppy diskette) coupled with bus 110 for storing information and instructions. Optionally, computer system 100 can include an alphanumeric input device 114 including alphanumeric and function keys coupled to bus 110 for communicating information and command selections to central processor(s) 102, a cursor control device 116 coupled to bus 110 for communicating user input information and command selections to central processor(s) 102, a signal generating device 118 coupled to bus 110 for communicating command selections to processor(s) 102, and a display screen 112 coupled to bus 110 for displaying information (e.g., graphics primitives) to the computer user. Display screen 112 utilized with computer system 100 of the present invention can be a liquid crystal device, cathode ray tube, or any other display screen suitable for creating graphic images and alphanumeric characters recognizable to the user.

Computer system 100 of FIG. 1 also provides data and control signals via bus 110 to a graphics hardware unit (“card”) 120. The graphics hardware card 120 typically contains a display processor 102′ and other specialized hardware units for processing a series of display instructions found within a memory stored display list to render graphics primitives. The display processor 102′ supplies data and control signals to a frame buffer (not shown) which refreshes the display screen 112 for rendering images (including graphics images). The graphics hardware card 120 is coupled to the display screen 112 by an address/data bus 110′, which enables them to communicate information.

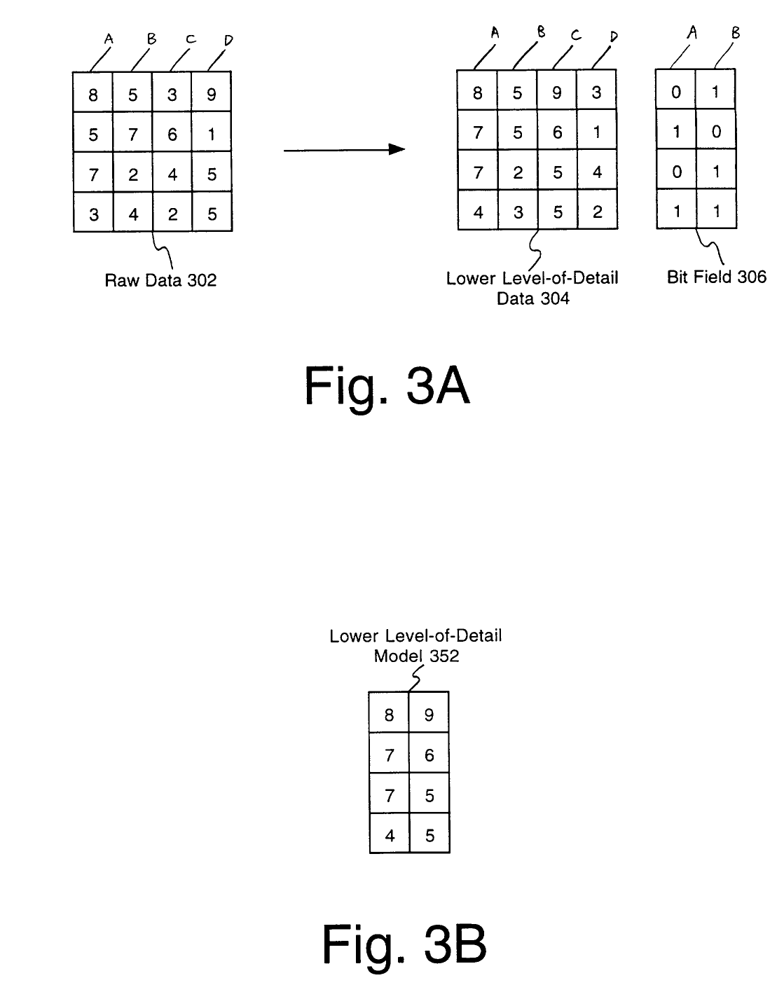

FIG. 2 is a flowchart of a method 200 in accordance with one embodiment of the present invention for graphically propagating modeling data corresponding to a high level-of-detail down to a lower level-of-detail using an asymmetric wavelet basis function. In order to more fully understand method 200, FIGS. 3A and 3B will be discussed in conjunction with FIG. 2. It should be appreciated that FIG. 3A is a block diagram illustrating one embodiment of how method 200 of FIG. 2 directs computer system 100 of FIG. 1 to propagate particular values of raw data 302 corresponding to a high level-of-detail down to data 304 corresponding to a lower level-of-detail. Furthermore, FIG. 3B is a block diagram illustrating one embodiment of the data used by method 200 to render a lower level-of-detail model 352 on display screen 112 of computer system 100.

In step 202 of FIG. 2, the present embodiment directs computer system 100 of FIG. 1 to start process 200. At step 204, the present embodiment directs computer system 100 to receive an asymmetric wavelet basis function. It should be appreciated that the present invention is well suited to utilize any type of asymmetric wavelet basis function. For example, an asymmetric wavelet basis function, in accordance with the present invention, could be either a biased averaging function, a square wave function, or any mathematical many to one function, but it is not in any way limited to interactions between pairs of data (e.g., an asymmetric wavelet basis function could operate on a line, circle, square, cube, N-dimensional cube, or any other type of relationship of data). In accordance with the present embodiment, the asymmetric wavelet basis function is entered into computer system 100 by a computer user. It should be further appreciated that the present invention is not limited in the manner in which an asymmetric wavelet basis function is entered into computer system 100.

In step 206 of FIG. 2, the present embodiment directs computer system 100 to receive raw scientific data which corresponds to a high level-of-detail (e.g., raw data 302 of FIG. 3A which is stored within memory unit 104). It should be appreciated that the present invention is well suited to receive scientific, engineering, or any other type of data. In accordance with the present embodiment, the raw scientific data is entered into computer system 100 by a computer user. It should be further appreciated that the present invention is not limited in the manner in which data is entered into computer system 100.

At step 208 of FIG. 2, the present embodiment directs computer system 100 to apply the asymmetric wavelet basis function to the raw data which corresponds to a high level-of-detail (e.g., raw data 302 of FIG. 3A) in order to generate data corresponding to a lower level-of-detail (e.g., data 304). For example, with reference to FIG. 3A, the asymmetric wavelet basis function used during step 208 on raw data 302 propagates the greater of two data values of raw data 302 in order to generate lower level-of-detail data 304. Specifically, the asymmetric wavelet basis function directs computer system 100 to compare adjacent data value pairs of raw data 302 and then switch the position of the data values if the greater one is not located in the left side position of the pair. The resulting location of the data value pairs after step 208 is the lower level-of-detail data 304. For example, the asymmetric wavelet basis function directs computer system 100 to compare the values of raw data 302A and 302B and determine if the greater value of the adjacent pair is located in the left position. Since raw data 302A has a greater value than raw data 302B and is located in the left position, their positioning remains unchanged and results in lower data 304A and 304B, respectively. Furthermore, the asymmetric wavelet basis function then directs computer system 100 to compare the values of the next adjacent pair of raw data values, raw data 302C and 302D, and determine if the greater value of the adjacent pair is located in the left position. Since raw data 302D has a greater value than raw data 302C and is located in the right side position of the pair, computer system 100 switches their positioning resulting in lower data 304C and 304D, respectively. In like manner, this same routine is continued though all of the data value pairs of raw data 302 resulting in the lower level-of-detail data 304.

In step 210 of FIG. 2, the present embodiment directs computer system 100 of FIG. 1 to store the data corresponding to the lower level-of-detail (e.g., data 304 of FIG. 3A) within exactly the same memory space as the original raw data (e.g., 302) occupied (e.g., memory unit 104 of FIG. 1). Therefore, with reference to FIG. 3A, the lower level-of-detail data 304 now occupies exactly the same memory space that was occupied by the raw data 302. As such, the result of step 208 as described above does not increase or decrease the data memory space, but instead keeps it the same. It should be appreciated that the present invention is well suited to store the data corresponding to the lower level-of-detail within any type of memory unit or device. It should be further appreciated that during step 210 the present embodiment is able to direct computer system 100 to store the data corresponding to the lower level-of-detail within the memory in any type of suitable data arrangement. For example, the present embodiment could direct computer system 100 during step 210 to store the data corresponding to the lower level-of-detail within the memory such that it is grouped together in a manner to take advantage of the particular hardware of computer system 100.

At step 212 of FIG. 2, the present embodiment directs computer system 100 to store bits within a bit field (e.g., bit field 304 of FIG. 3A) for decoding the data which corresponds to the lower level-of-detail (e.g., data 304). For example, with reference to FIG. 3A, since the data values of the lower level-of-detail data 304A and 304B were not switched by computer system 100 during step 208, the present embodiment directs computer system 100 to store a 0 bit value within bit field position 306A. Furthermore, since the data values of the lower level-of-detail 304C and 304D were switched by computer system 100 during step 208, the present embodiment directs computer system 100 to store a 1 bit value within bit field position 306B. In this manner, the present embodiment directs computer system 100 to store bit values within bit field 306. The reason for implementing a bit field (e.g., 306) within the present embodiment is to enable it to be used in conjunction with the data corresponding to the lower level-of-detail (e.g., data 304) in order to reproduce at some later time the original raw data (e.g., data 302), which process is discussed below. It should be appreciated that one embodiment of the bit field, in accordance with the present invention, can be implemented as a buffer or an array which typically utilizes much less memory space (e.g., 64 to 1024 times less memory space) than the original raw data.

In step 214 of FIG. 2, the present embodiment directs computer system 100 to render the data corresponding to the lower level-of-detail on display screen 112 of FIG. 1. For example, within FIGS. 3A that data is all the larger data values located within the left position of the lower level-of-detail data 304. Specifically, the column of data values beneath and including data 304A and 304C as shown in FIG. 3B as a lower level-of-detail model 352. It should be appreciated that FIG. 3B is a block diagram illustrating one embodiment of the data used in step 214 to render a lower level-of-detail model 352 on display screen 112 of computer system 100. In step 216, the present embodiment directs computer system 100 to exit process 200 because the graphical model of the lower level-of-detail has been rendered on display screen 112.

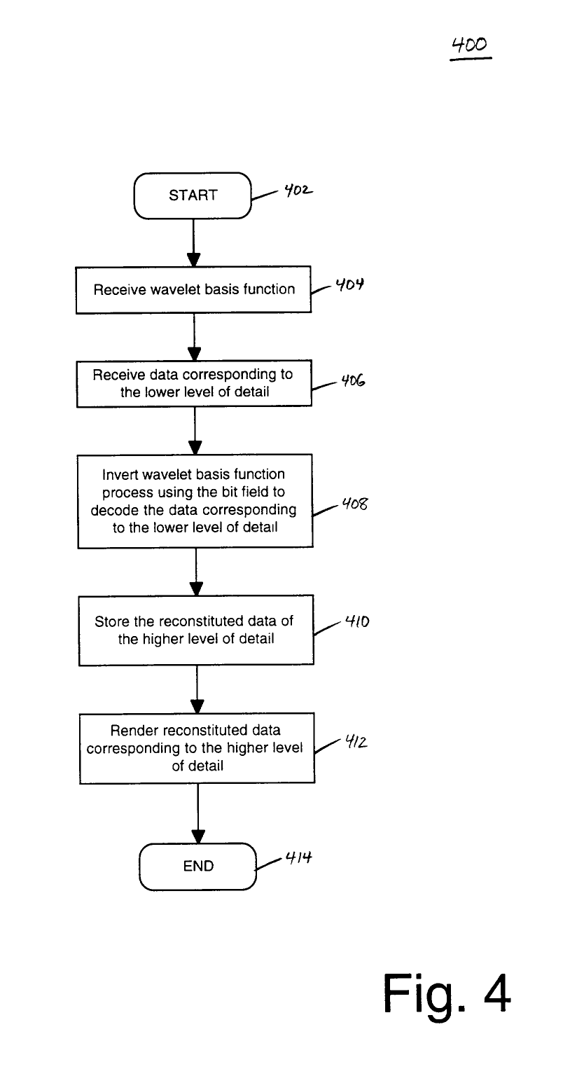

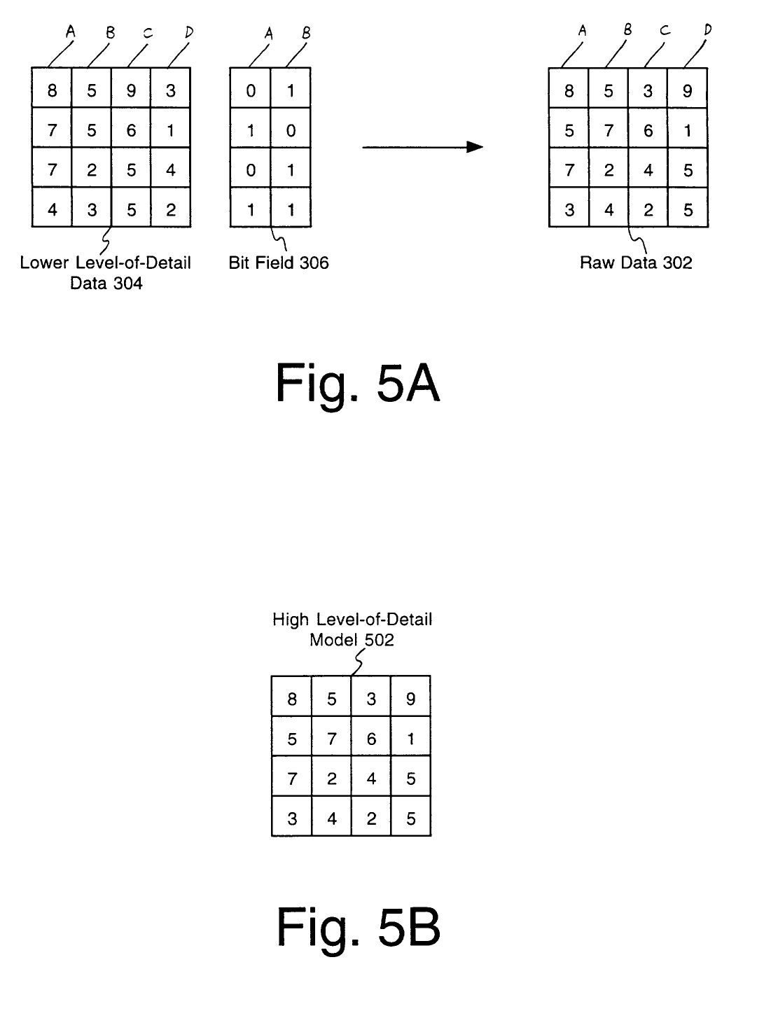

FIG. 4 is a flowchart of a method 400 in accordance with one embodiment of the present invention for graphically reconstituting modeling data corresponding to a higher level-of-detail from data corresponding to a lower level-of-detail by inverting an asymmetric wavelet basis function process. In order to more fully understand method 400, FIGS. 5A and 5B will be discussed in conjunction with FIG. 4. It should be appreciated that FIG. 5A is a block diagram illustrating one embodiment of how method 400 of FIG. 4 directs computer system 100 of FIG. 1 to reconstitute raw data 302 corresponding to a higher level-of-detail by utilizing a bit field 306 and data 304 corresponding to a lower level-of-detail. Furthermore, FIG. 5B is a block diagram illustrating one embodiment of the data used by method 400 to render a high level-of-detail model 502 on display screen 112 of computer system 100.

In step 402 of FIG. 4, the present embodiment directs computer system 100 of FIG. 1 to start process 400. At step 404, the present embodiment directs computer system 100 to receive an asymmetric wavelet basis function which was previously used to during process 200 of FIG. 2. It should be appreciated that the present invention is well suited to utilize any type of asymmetric wavelet basis function. For example, an asymmetric wavelet basis function, in accordance with the present invention, could be either a biased averaging function, a square wave function, or any mathematical many to one function, but it is not in any way limited to interactions between pairs of data (e.g., an asymmetric wavelet basis function could operate on a line, circle, square, cube, N-dimensional cube, or any other type of relationship of data). In accordance with the present embodiment, the asymmetric wavelet basis function is entered into computer system 100 by a computer user. It should be further appreciated that the present invention is not limited in the manner in which an asymmetric wavelet basis function is entered into computer system 100.

In step 406 of FIG. 4, the present embodiment directs computer system 100 to receive scientific data corresponding to the lower level-of-detail (e.g., raw data 302 of FIG. 3A which is stored within memory unit 104) resulting from process 200 of FIG. 2. It should be appreciated that the present invention is well suited to receive scientific, engineering, or any other type of data. In accordance with the present embodiment, the raw scientific data is entered into computer system 100 by a computer user. It should be further appreciated that the present invention is not limited in the manner in which data is entered into computer system 100.

At step 408 of FIG. 4, the present embodiment directs computer system 100 to invert the asymmetric wavelet basis function process of process 200 of FIG. 2 by utilizing the bit field (e.g., bit field 306 of FIG. 5A) to decode the data corresponding to the lower level-of-detail (e.g., data 304). It should be appreciated that in order to fully understand the following example of step 408 utilizing FIG. 5A, it is necessary to understand the processes of producing the bit field 306 and data 304 corresponding to the lower level-of-detail. As such, these processes are described above within steps 208-212 of FIG. 2.

With reference to FIG. 5A, a 0 bit value within bit field position 306A indicates to the present embodiment that the location of lower data 304A and 304B were not switched by computer system 100 during step 208 of process 200 of FIG. 2. Furthermore, a 1 bit value within bit field position 306B indicates to the present embodiment that the location of lower data 304C and 304D were switched by computer system 100 during step 208 of process 200. As such, at step 408, the present embodiment directs computer system 100 to switch the positioning of the values of lower data 304D and 304C, resulting in raw data 302C and 302D, respectively. Furthermore, at step 408, the present embodiment directs computer system 100 to leave the positioning of the values of lower data 304A and 304B unchanged, resulting in raw data 302A and 302B, respectively. In like manner, this same routine is continued though all of the data value pairs of the lower level-of-detail data 304 resulting in raw data 302.

In step 410 of FIG. 4, the present embodiment directs computer system 100 of FIG. 1 to store the reconstituted data corresponding to the higher level-of-detail (e.g., raw data 302 of FIG. 5A) within exactly the same memory space as the data corresponding to the lower level-of-detail (e.g., data 304) occupied (e.g., memory unit 104 of FIG. 1). Therefore, with reference to FIG. 5A, the higher level-of-detail data 302 now occupies exactly the same memory space that was occupied by the lower level-of-detail data 304. As such, the result of step 408 as described above does not increase or decrease the data memory space, but instead keeps it the same. It should be appreciated that the present invention is well suited to store the data corresponding to the lower level-of-detail within any type of memory unit or device.

At step 412 of FIG. 4, the present embodiment directs computer system 100 to render the data corresponding to the higher level-of-detail (e.g., raw data 302 of FIG. 5A) on display screen 112 of FIG. 1. It should be appreciated that FIG. 5B is a block diagram illustrating one embodiment of the data used in step 412 to render a high level-of-detail model 502 on display screen 112 of computer system 100. In step 414, the present embodiment directs computer system 100 to exit process 400 because the graphical model of the higher level-of-detail has been rendered on display screen 1 12.

Thus, the present invention provides a method of performing computer graphics multi-resolution analysis with information propagation. For instance, if a broad overview of a computer graphics model is being viewed and one specific value is very important to a computer user, the present invention provides a method which causes that value to become conspicuous. Moreover, within the present invention, an asymmetric basis function can skew a chosen piece of information so that it has a spreading effect at a low level-of-detail, so it has a region of increase. Therefore, the data is not directly transmitted between different levels-of-detail, but instead spreads so that it has a higher region of influence. Additionally, the present invention provides a method of graphically simplifying scientific data while not losing any information at different levels-of-detail. Furthermore, the present invention provides a method of compact storage of scientific data for graphical rendering, which contains all of the original information while allowing the propagation of specific information into different graphical levels-of-detail. Specifically, the memory space used to store the original data, in accordance with the present invention, substantially maintains the same size as different graphics levels-of-detail of a model are rendered on a computer display screen. Moreover, another advantage of the present invention is that it allows graphical dynamic zooming of any sub-section of data of a graphical model (e.g., even a single “pixel” may be zoomed or a small group of data can be simplified). As such, the present invention enables roaming and zooming of graphical models along with the simultaneous use of many levels-of-detail.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A computer readable medium having computer readable code embodied therein for causing a computer to perform the steps of:
(a) using an asymmetric wavelet basis function to generate data corresponding to a first graphical model based on data corresponding to a second graphical model, wherein said second graphical model has a higher level-of-detail than said first graphical model;
(b) storing said data corresponding to said first graphical model over said data corresponding to said second graphical model that was used during step (a);
(c) storing a value within a bit field for decoding said data corresponding to said first graphical model;
(d) rendering said data corresponding to said first graphical model on a display screen of said computer.

2. A computer readable medium as described in claim 1 further causing said computer to perform the additional steps of:
(a) reconstituting said data corresponding to said second graphical model by inverting said asymmetric wavelet basis function using said value stored within said bit field and said data corresponding to said first graphical model;
(b) storing said data corresponding to said second graphical model over said data corresponding to said first graphical model that was used during step (a); and
(c) rendering said data corresponding to a said second graphical model on said display screen of said computer.

3. A computer readable medium as described in claim 1 wherein said data corresponding to said second graphical model is scientific or engineering data.

4. A computer readable medium as described in claim 1 wherein said asymmetric wavelet basis function is a biased averaging function.

5. A computer readable medium as described in claim 1 wherein said asymmetric wavelet basis function is a square wave function.

6. A computer readable medium as described in claim 1 wherein said asymmetric wavelet basis function is any mathematical many to one function.

7. A computer readable medium as described in claim 2 wherein said bit field is an array or buffer.

8. A computer readable medium as described in claim 2 wherein said data corresponding to said second graphical model is engineering or scientific data.

9. In a computer system, a method for rendering accurate computer graphics models together with their corresponding accurate levels-of-detail without having to store repetitive data representing each level-of-detail, said method comprising the computer implemented steps of:
(a) reconstituting data corresponding to a first graphical model by inverting an asymmetric wavelet basis function using a value stored within a bit field and data corresponding to a second graphical model, wherein said first graphical model has a higher level-of-detail than said second graphical model;
(b) storing said data corresponding to said first graphical model in memory over said data corresponding to said second graphical model that was used during step (a); and
(c) rendering said data corresponding to said first graphical model on said display screen of said computer.

10. A method as described in claim 9 further comprising the computer implemented steps of:
(a) using said asymmetric wavelet basis function to generate said data corresponding to said second graphical model based on said data corresponding to said first graphical model;
(b) storing said data corresponding to said second graphical model in memory over said data corresponding to said first graphical model that was used during step (a);
(c) storing a value within a bit field, wherein said value for decoding said data corresponding to said second graphical model;
(d) rendering said data corresponding to said second graphical model on a display screen of said computer.

11. A method as described in claim 9 wherein said data corresponding to said first graphical model is engineering or scientific data.

12. A method as described in claim 10 wherein said data corresponding to said first graphical model is engineering or scientific data.

13. A method as described in claim 11 wherein said asymmetric wavelet basis function is a biased averaging function.

14. A method as described in claim 11 wherein said asymmetric wavelet basis function is a square wave function.

15. A method as described in claim 11 wherein said asymmetric wavelet basis function is any mathematical many to one function.

16. A method as described in claim 12 wherein said bit field is a buffer or array.

17. A computer system comprising:
a processor;
an addressable data bus coupled to said processor;
a computer readable memory coupled to communicate with said processor for performing a method for rendering accurate computer graphics models together with their corresponding accurate levels-of-detail without having to store repetitive data representing each level-of-detail comprising the steps of:
(a) using an asymmetric wavelet basis function to generate data corresponding to a first graphical model based on data corresponding to a second graphical model, wherein said second graphical model has a higher level-of-detail than said first graphical model;
(b) storing said data corresponding to said first graphical model in memory over said data corresponding to said second graphical model that was used during step (a);
(c) storing a value within a bit field, wherein said value for decoding said data corresponding to said first graphical model;
(d) rendering said data corresponding to said first graphical model on a display screen of said computer.

18. A computer system as described in claim 17 further comprising the steps of:
(a) reconstituting said data corresponding to said second graphical model by inverting said asymmetric wavelet basis function using said value stored within said bit field and said data corresponding to said first graphical model;
(b) storing said data corresponding to said second graphical model in memory over said data corresponding to said first graphical model that was used during step (a); and
(c) rendering said data corresponding to said second graphical model on said display screen of said computer.

19. A computer system as described in claim 17 wherein said data corresponding to said second graphical model is scientific or engineering data.

20. A computer system as described in claim 18 wherein said data corresponding to said second graphical model is scientific or engineering data.

21. A computer system as described in claim 20 wherein said asymmetric wavelet basis function is a biased averaging function.

22. A computer system as described in claim 20 wherein said asymmetric wavelet basis function is a square wave function.

23. A computer system as described in claim 20 wherein said asymmetric wavelet basis function is any mathematical many to one function.

24. A computer system as described in claim 23 wherein said bit field is a buffer or array.
